(19) United States
(12) Patent Application Publication
(10) Pub. No.: US 2005/0062815 A1
(43) Pub. Date: Mar. 24, 2005

(54) Ink supplying apparatus and recording apparatus

(75) Inventors: Rai Yoshihira, Ebina-shi (JP); Hiroshi Ikeda, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/887,336

(22) Filed: Jul. 9, 2004

(30) Foreign Application Priority Data
Jul. 10, 2003 (JP) 2003-194855

(51) Int. Cl. B41J 2/18

(52) U.S. Cl. 347/89

(57) ABSTRACT

Ink in a subtank is sent to an ink circulation path via an ink supply path, and is further returned from the ink circulation path to the subtank via an ink return path. Moreover, the ink is sent from a main tank to the subtank and returned to the main tank from the subtank. Because the ink is circulated not only between the subtank and recording heads but also between the main tank and the subtank, the ink is stably supplied to the recording heads.

### CROSS-REFERENCE TO RELATED APPLICATION

This application claims priority under 35 USC 119 from Japanese Patent Application No. 2003-194855, the disclosure of which is incorporated by reference herein.

### BACKGROUND OF THE INVENTION

1. Field of the Invention

The present invention relates to an ink supplying apparatus and a recording apparatus, and in particular to a recording apparatus used as an output device, such an inkjet recording apparatus that conducts recording by discharging ink onto a recording medium, a fax machine, a copier, a printer composite device and a workstation disposed with such a function, and to an ink supplying apparatus used in the recording apparatus.

2. Description of the Related Art

In recent years, the spread of color documents in offices has been remarkable, and various output devices for that purpose have been proposed. In particular, the inkjet format, which is inexpensive and with which miniaturization is possible, is used in various output devices.

Recording heads used in the inkjet format are configured by an energy generator, an energy converter that converts the energy generated by the energy generator into ink discharging power, ink discharge ports through which ink droplets are discharged by the ink discharging power, and an ink supply path that communicates with the ink discharge ports and supplies the ink. As the energy generator, there is an energy generator using an electromechanical converter such as a piezo element, and an energy generator where the ink is heated by an electrothermal conversion element to generate air bubbles so that ink droplets are discharged by the generation of the air bubbles.

With a recording head using an electrothermal conversion element, it is not only possible to dispose the ink discharge ports at a high density because the electrothermal conversion element is compact, but a recording head disposed with numerous high-precision ink discharge ports can be miniaturized and manufactured at a low cost because it is possible to use a semiconductor integrated circuit fabrication technique as the technique for manufacturing the recording head.

However, the printing format that is mainly spreading at present is a printing format called serial scanning, where printing is conducted per line by reciprocally moving the recording head as recording paper is being conveyed. This format is compact and inexpensive, but there is a drawback in that plural scans with the recording head become necessary in order to form an image across the entire paper, so the printing speed is slow. In order to improve the printing speed, it is necessary to reduce the number of scans, and elongation of the recording head becomes essential. That which has pushed this to the limit is a non-scanning printing format conducted by a paper-width recording head.

In this manner, in order to improve the printing speed and be able to accommodate office use, inkjet recording apparatus have been proposed where a sheet of paper is continuously conveyed and printed by a non-scanning type recording head corresponding to the paper width.

Usually, a recording apparatus disposed with a non-scanning type recording head often has a configuration disposed with plural recording heads (or unit heads). Even a recording apparatus that records an image with a recording head that is not a non-scanning type sometimes has a configuration disposed with plural recording heads.

In a recording apparatus disposed with plural recording heads, the amount of ink consumed per unit time is large, and it is necessary to stably supply ink to the recording heads to maintain the printing quality.

For example, Japanese Patent Application Laid-Open Publication (JP-A) No. 11-91130 discloses an inkjet printer of a configuration where the ink is circulated between an ink tank and a printing head. In this inkjet printer, when the level of the ink inside the ink tank reaches a predetermined height or higher, the ink overflows so that the level of the ink becomes constant and variations in the ink pressure acting on the discharge ports are suppressed.

However, in the conventional configuration described in JP-A No. 11-91130, an ink replenishing cassette that supplies the ink to the ink tank is simply loaded in the ink tank. Thus, there is the potential for the supply of ink from the ink replenishing cassette to the ink tank to become unstable.

### SUMMARY OF THE INVENTION

The present invention has been made in light of the above-described circumstances. In accordance with a first aspect of the invention, there is provided an ink supplying apparatus including: a recording head unit; a first tank and a second tank that can retain ink for the recording head unit; a first circulation device that can circulate the ink between the recording head unit and the first tank; and a second circulation device that can circulate the ink between the first tank and the second tank.

In accordance with another aspect of the invention, there is provided a recording apparatus including: (i) plural recording heads that can discharge ink droplets onto a recording medium; and (ii) an ink supplying apparatus that can supply ink to the recording heads, the ink supplying apparatus including a first tank and a second tank that can retain the ink, a first circulation device that can circulate the ink between the recording heads and the first tank, and a second circulation device that can circulate the ink between the first tank and the second tank.

The “recording medium” serving as the target of image recording in the present invention widely includes targets to which ink droplets are discharged. Also, dot patterns on the recording medium obtained as a result of the ink droplets adhering to the recording medium are widely included in the “image” or “recording image” obtained with the present invention. Thus, the present invention is not limited to a device used to record characters and images on recording paper. Of course, recording paper and OHP sheets are included in the recording medium, but in addition to these, substrates on which a wiring pattern is formed are also included. Also, included in the “image” are not only common images (characters, illustrations, photographs, etc.) but also the aforementioned wiring pattern, three-dimensional objects and organic thin films. The liquid to be discharged is also not limited to color ink. For example, the recording apparatus of the present invention can be applied to common droplet jetting devices used for various industrial purposes, such as the manufacture of color filters for displays conducted by discharging color ink onto a polymer film or glass, the formation of bumps for parts packaging conducted by discharging molten solder onto a substrate, the formation of EL display panels conducted by discharging an organic EL solution onto a substrate, and the formation of bumps for electrical packaging conducted by discharging molten solder onto a substrate.

### BRIEF DESCRIPTION OF THE DRAWINGS

Preferred embodiments of the present invention will be described in detail based on the following figures, wherein:

FIG. 1 is a schematic configural diagram showing a recording apparatus of the invention;

FIG. 2 is a conceptual diagram showing an example of the basic configuration of an ink supplying apparatus of the invention;

FIG. 3 is a conceptual diagram showing the basic configuration of an ink supplying apparatus of the invention that is different from the configuration shown in FIG. 2;

FIG. 4 is a conceptual diagram showing the basic configuration of an ink supplying apparatus of the invention corresponding to a recording apparatus where recording heads are plurally arranged;

FIG. 5 is a conceptual diagram showing the basic configuration of an ink supplying apparatus of the invention corresponding to a recording apparatus where recording heads are plurally arranged, which configuration is different from the configuration shown in FIG. 4;

FIG. 6 is a schematic configural diagram showing a recording apparatus of the invention;

FIG. 7 is an explanatory diagram of a printing region of the recording apparatus pertaining to an embodiment of the invention;

FIG. 8 is an explanatory diagram of a modified example of a unit head pertaining to the embodiment of the invention;

FIG. 9 is an explanatory diagram of a modified example of a recording head pertaining to the embodiment of the invention;

FIG. 10 is an explanatory diagram of a modified example of a unit head pertaining to the embodiment of the invention;

FIG. 11 is an explanatory diagram of a modified example of a recording head pertaining to the embodiment of the invention;

FIG. 12 is an explanatory diagram of a modified example of a recording head pertaining to the embodiment of the invention; and

FIG. 13 is an explanatory diagram of a modified example of a unit head pertaining to the embodiment of the invention.

### DETAILED DESCRIPTION OF THE INVENTION

[Basic Configuration]

First, the basic configuration of an ink supplying apparatus of the invention will be described.

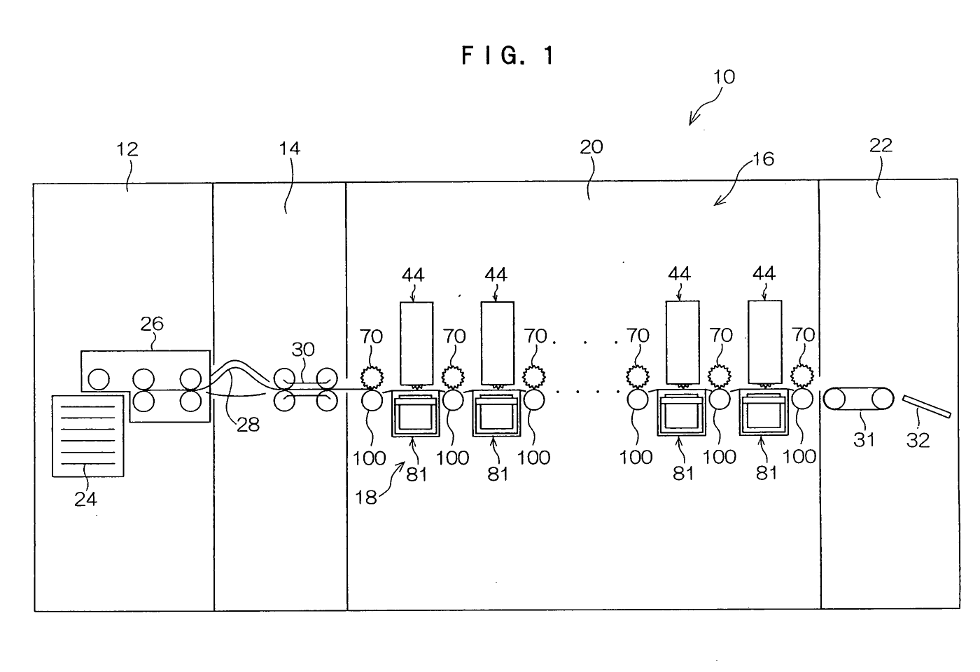

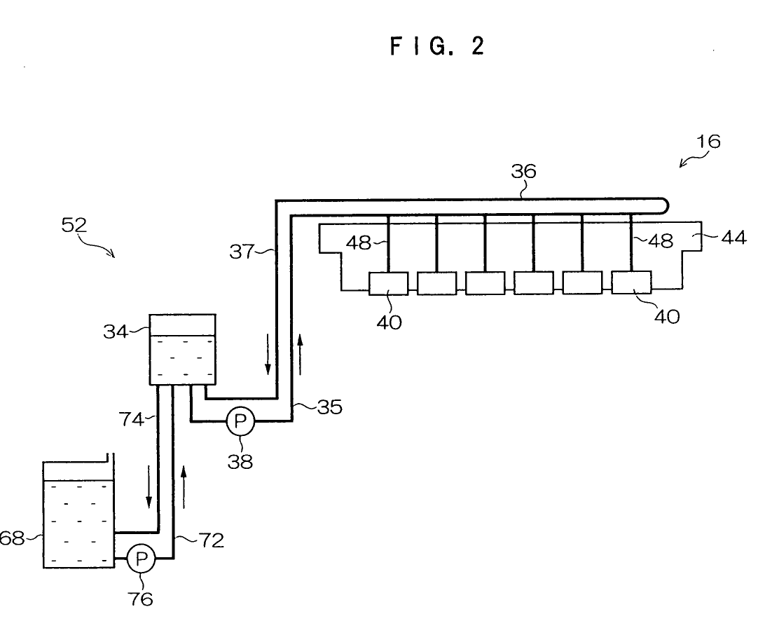

FIG. 2 shows the basic configuration of an ink supplying apparatus 52 of the invention. FIG. 1 shows an inkjet recording apparatus 10 to which the ink supplying apparatus 52 has been applied.

As shown in FIG. 1, the inkjet recording apparatus 10 is basically configured by a paper supply section 12 that sends paper, a registration adjustment section 14 that controls the orientation of the paper, a recording section 20 disposed with a recording head unit 16 that forms an image on the paper by discharging ink droplets and a maintenance unit 18 that maintains the recording head unit 16, and an ejection section 22 that ejects the paper on which an image has been formed by the recording section 20.

The paper supply section 12 is configured by a stocker 24, in which sheets of the paper are stacked and stocked, and a conveyance device 26 that removes the paper one sheet at a time from the stocker 24 and sends the paper to the registration adjustment section 14.

The registration adjustment section 14 is disposed with a loop forming unit 28 and a guide member 30 that controls the orientation of the paper. The paper passes through this section, whereby the skewing of the paper is corrected by utilizing the stiffness of the paper, and then the paper enters the recording section 20 by the control of the conveyance timing.

The recording section 20 configures a paper conveyance path where the paper is conveyed between the recording head unit 16 and the maintenance unit 18. The paper is nipped by star wheels 70 and conveyance rolls 100 and continuously (without stopping) conveyed. Ink droplets are discharged from the recording head unit 16 onto the paper to form an image on the paper. The recording head unit 16 and the maintenance unit 18 are respectively unitized, and the recording head unit 16 is configured to be separable (specifically, movable upward) from the maintenance unit 18 with the paper conveyance path therebetween. Thus, in the event of a paper jam, the paper with which the inkjet recording apparatus is jammed can be easily removed.

The ejection section 22 receives, in an ejection tray 32 via a paper ejection belt 31, sheets of the paper on which images have been formed by the recording section 20.

As shown in FIG. 2, the recording head unit 16 is disposed with at least plural recording heads 44 corresponding to the respective colors of the ink-jet recording apparatus 10. Each recording head 44 is disposed with plural unit heads 40. Ink droplets are discharged onto the paper from ink discharge ports (nozzles) disposed in the unit heads 40, whereby an image is recorded on the paper.

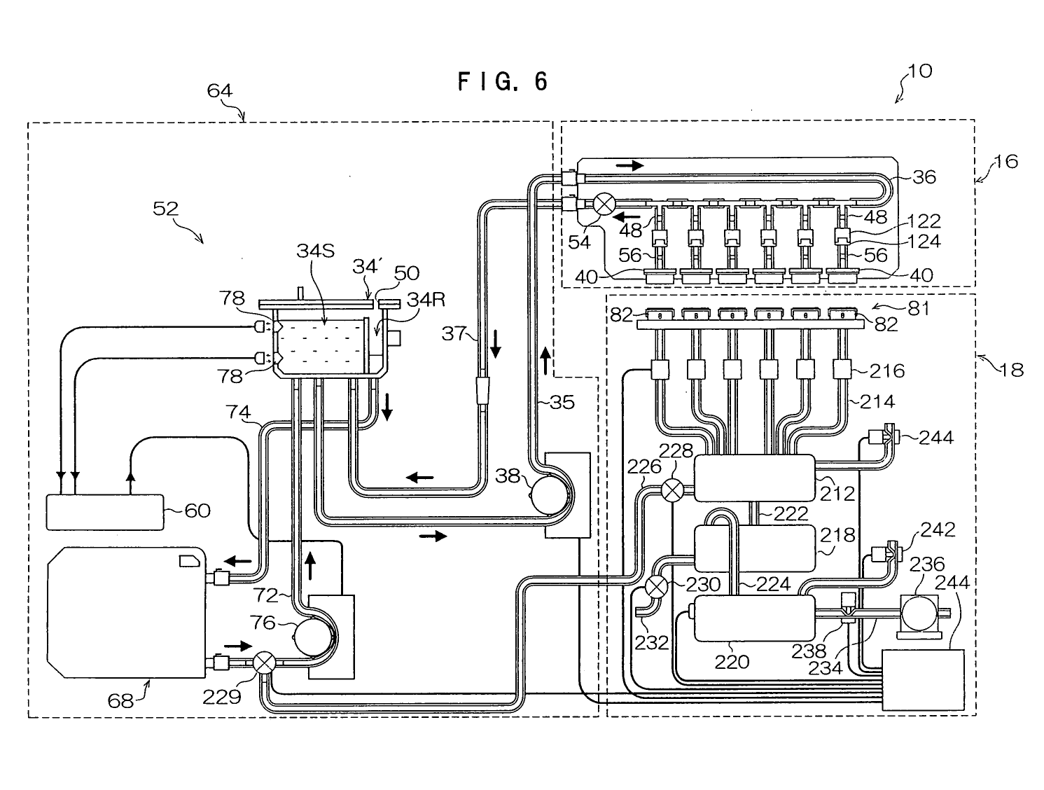

A subtank 34 is disposed inside the inkjet recording apparatus. Ink used in image recording is temporarily accommodated in the subtank 34. The recording head 44 is disposed with a loop-shaped ink circulation path 36. The ink in the subtank 34 is sent to the ink circulation path 36 via an ink supply path 35 and is further returned to the subtank 34 from the ink circulation path 36 via an ink return path 37. A circulation path open/close valve 54 (see FIG. 6) is disposed in the ink circulation path 36. By opening the circulation path open/close valve 54 and driving a subpump 38, the ink circulates through the ink circulation path 36 and returns to the subtank 34.

Individual flow paths 48, which correspond to the unit heads 40, extend from the ink circulation path 36. An individual open/close valve (not shown) is disposed in each individual flow path 48. By opening only the individual open/close valve corresponding to a specific unit head 40 and closing the other individual open/close valves, it is possible to supply ink only to a desired unit head 40.

Moreover, the ink supplying apparatus 52 is disposed with a main tank 68 in which the ink is stored in advance. The main tank 68 and the subtank 34 communicate with each other through a main supply path 72 and a main return path 74. The ink can be sent from the main tank 68 to the subtank 34 by a main pump 76 disposed in the main supply path 72, and the ink can be returned from the subtank 34 to the main tank 68.

In the configuration shown in FIG. 2, the ink is not only circulated by the subpump 38 through the ink supply path 35, the ink circulation path 36 and the ink return path 37 between the subtank 34 and the recording head 44 (the plural unit heads 40), but is also circulated by the main pump 76 through the main supply path 72 and the main return path 74 between the main tank 68 and the subtank 34. Thus, the ink stored in the main tank 68 can be stably supplied to the subtank 34, and the ink retained in the subtank 34 can be stably supplied to the recording heads 44 (each unit head 40). For example, even in a case where a large amount of ink is discharged in a short amount of time from the recording heads 44, ink necessary for image recording is always stably supplied to the recording head 44.

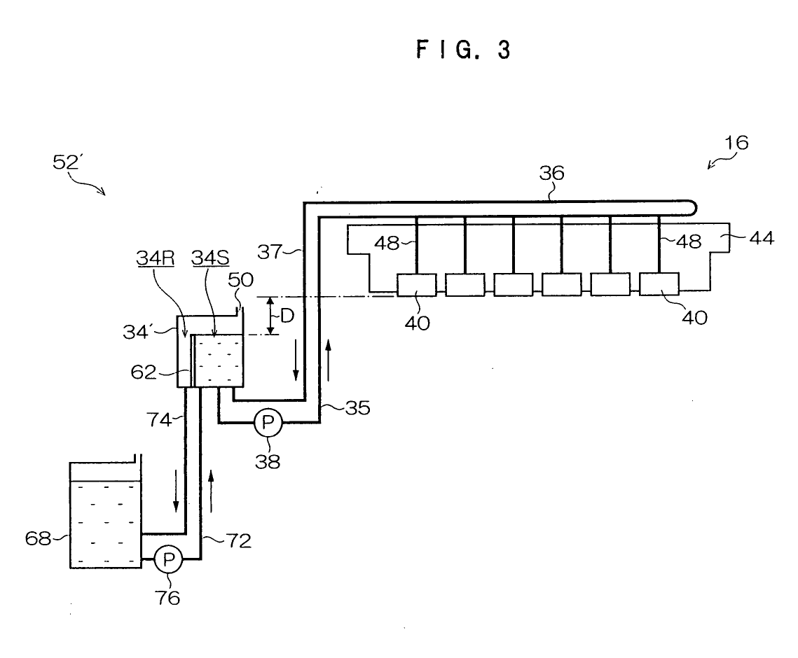

FIG. 3 shows the basic configuration of an ink supplying apparatus 52′ that is different from the configuration shown in FIG. 2. The ink supplying apparatus 52′ shown in FIG. 3 is substantially identical to the ink supplying apparatus 52 shown in FIG. 2, except that the configuration of a subtank 34′ is different.

An atmosphere communication hole 50 is formed in an upper wall of the subtank 34′, and a water head difference D is generated by the difference in height between the level of ink in the subtank 34′ and the ink discharge plane of the recording head 44 (unit heads 40).

Also, an overflow wall 62 is disposed inside the subtank 34′, so that the inside of the subtank 34′ is divided into an ink retention chamber 34S and an ink return chamber 34R. The main supply path 72, the ink supply path 35 and the ink return path 37 are all connected to the ink retention chamber 34S, and only the main return path 74 is connected to the ink return chamber 34R.

The ink sent from the main tank 68 or the ink returned from the recording head 44 is retained in the ink retention chamber 34S, but when the amount of ink exceeds a constant amount, the ink flows over the overflow wall 62 and into the ink return chamber 34R. By sending a sufficient amount of ink into the ink retention chamber 34S, the height of the ink level inside the ink retention chamber 34S can always be maintained at a constant. Thus, regardless of the capacity and shape of the subtank 34′, a constant water head difference D is always obtained between the level of ink inside the subtank 34′ and the nozzle plane of the recording head 44.

The ink in the ink return chamber 34R is returned to the main tank 68 via the main return path 74. It is not invariably necessary to return the ink to the main tank 68 in order to maintain the level of ink inside the subtank 34′ at a constant; the ink in the ink return chamber 34R may also simply be disposed of.

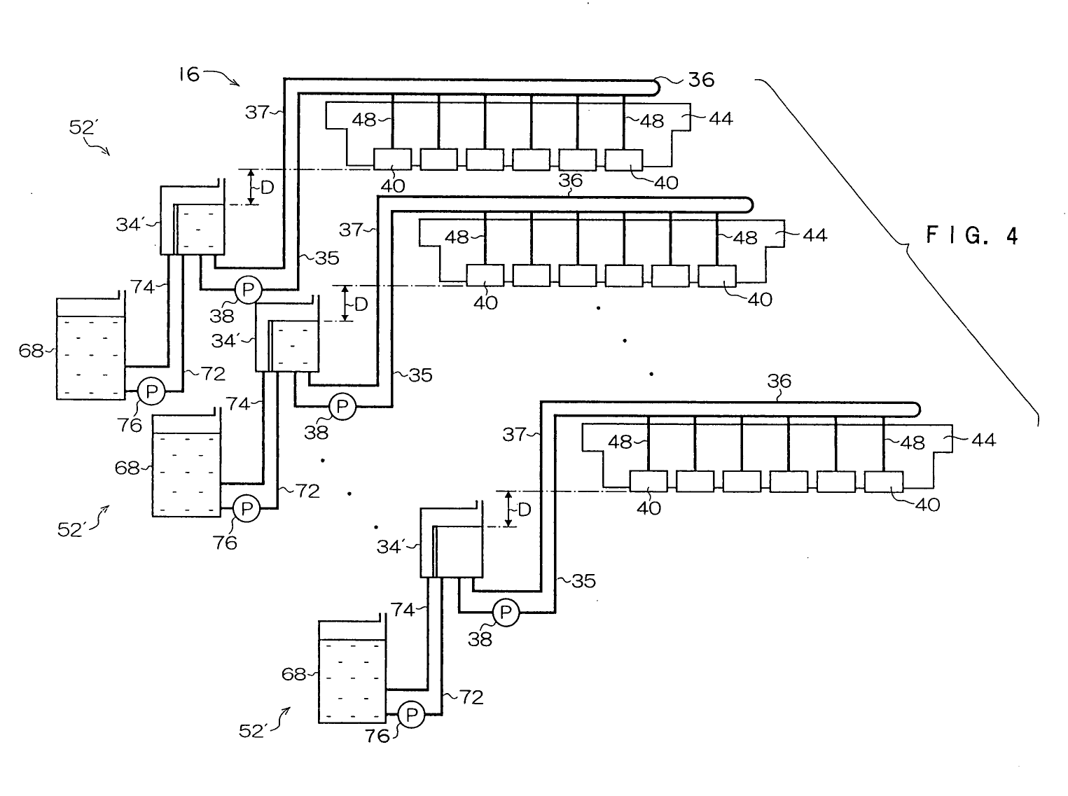

As another example of the basic configuration of the invention, FIG. 4 shows an ink supplying apparatus 52′ where the recording head 44 shown in FIG. 3 is plurally arranged in one direction.

In this configuration, it is possible for the respective recording heads 44 to discharge ink droplets of the same color and to discharge ink droplets of respectively different colors. For example, a full-color image can be recorded by disposing four or more of the recording heads 44 and enabling the recording heads 44 to discharge ink droplets of at least the four colors of yellow (Y), magenta (M), cyan (C) and black (K).

As one example, the plural recording heads 44 are lined up and disposed at predetermined intervals (which do not have to be constant) in the direction orthogonal to the arrangement direction of the unit heads 40, and the same number of subtanks 34′ are disposed in correspondence to these recording heads 44. Each recording head 44 is disposed with a main circulation device and a subcirculation device. An overflow device (overflow wall 62) and a return device that are the same as those of the basic configuration shown in FIG. 3 are disposed in the subtanks 34′.

With the ink supplying apparatus 52′ shown in FIG. 4, ink can be stably supplied to the plural recording heads 44 (unit heads 40).

Also, a constant water head difference D can always be obtained between the subtanks 34′ and the nozzle planes of the recording heads 44.

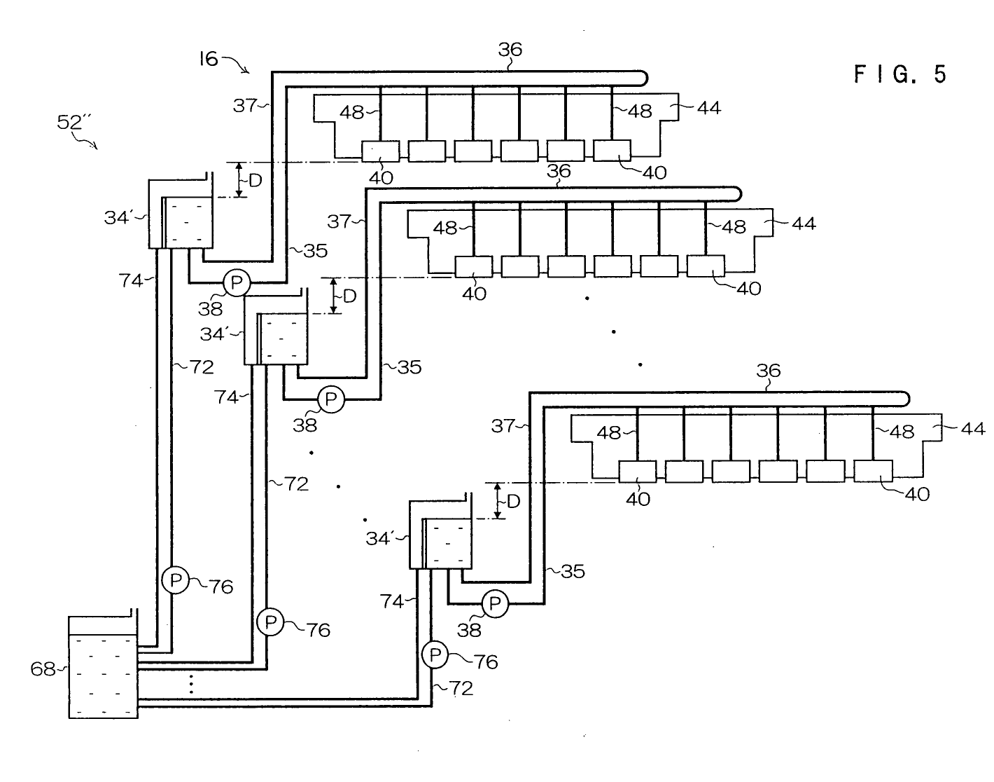

As an ink supplying apparatus corresponding to a recording apparatus where plural recording heads 44 are disposed, an ink supplying apparatus 52″ shown in FIG. 5 can be adopted instead of the ink supplying apparatus 52′ shown in FIG. 4. In the ink supplying apparatus 52″ of FIG. 5, a main tank 68 is shared for each of the yellow, magenta, cyan and black colors, the number of main tanks 68 is reduced overall, and the structure of the ink supplying apparatus can be simplified.

[Embodiment]

Next, an embodiment of the invention will be described. This embodiment adopts the basic configuration shown in FIG. 4.

FIG. 6 shows an ink supply unit 64, the maintenance unit 18 and the recording head unit 16 of the inkjet recording apparatus 10 of the present embodiment.

The ink supply unit 64 includes the main tank 68 in which the ink is stored in advance and the subtank 34′ in which the ink sent from the main tank 68 is temporarily retained. The main tank 68 and the subtank 34′ communicate with each other through the main supply path 72 and the main return path 74. The ink can be sent from the main tank 68 to the subtank 34′ by the main pump 76 disposed in the main supply path 72, and the ink can be returned from the subtank 34′ to the main tank 68.

The ink circulation path 36 (see FIGS. 2 to 5) is connected to the subtank 34′ via the ink supply path 35 and the ink return path 37, and the ink in the subtank 34 can be returned to the ink circulation path 36 by the driving of the subpump 38.

The overflow wall 62 is vertically disposed inside the subtank 34′. The inside of the subtank 34′ is divided by the overflow wall 62 into the ink retention chamber 34S and the ink return chamber 34R. The main supply path 72, the ink supply path 35 and the main return path 74 are connected to the underside of the ink retention chamber 34S, and the main return path 74 is connected to the underside of the ink return chamber 34R.

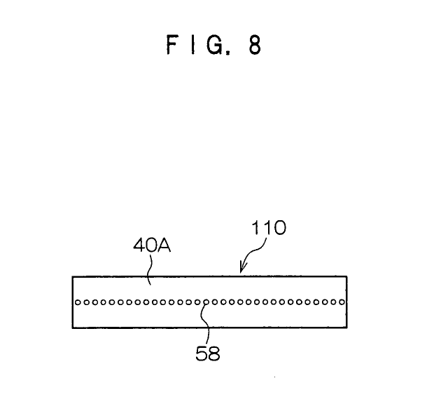

The atmosphere communication hole 50 is formed in an upper cover of the subtank 34′, so that the inside of the subtank 34′ is maintained at atmospheric pressure. The recording head 44 and the subtank 34′ are disposed so that a predetermined height difference is disposed between the ink discharge ports (see later-described FIG. 8) of the unit heads 40 and the level of the ink in the ink retention chamber 34S of the subtank 34′, whereby the water head difference D is disposed therebetween. In the present invention, the overflow wall 62 is disposed, whereby the level of the ink in the ink retention chamber 34S does not rise thereabove. Thus, the water head difference D can always be stably maintained.

Level sensors 78 that detect the level of the ink are disposed in the ink retention chamber 34S of the subtank 34′. The information of the level detected by the level sensors 78 is sent to an ink supply controller 60, and the main pump 76 is controlled on the basis of this information.

It is preferable for the main supply path 72, the main return path 74, the ink supply path 35, the ink circulation path 36, the ink return path 37 and the individual flow paths 48 to be ink-resistant and configured by tubes formed by a material that is rigid enough so that the tubes do not inadvertently collapse with respect to the pressure from the ink (depending on the case, negative pressure).

Moreover, in a case where roller pumps are used as the main pump 76 and the subpump 38, it is necessary for the tubes to be flexible (elastic) enough so that the tubes are appropriately collapsed (become locally recessed or bend) by an external force. Various kinds of rubber and resin can be used as the specific tube material. Specific examples thereof include polyethylene, polypropylene, nylon, polyvinylidene chloride, vinyl acetate, and copolymers of these such as an ethylene/vinyl acetate copolymer, an ethylene/acrylic acid copolymer, an ethylene/methyl acrylate copolymer, an ethylene/methacrylic acid copolymer, an ethylene/methyl methacrylate copolymer, and a polyethylene/vinyl alcohol copolymer. In terms of ink resistance, PVC (polyvinyl chloride resin) tubes, tygon tubes (“tygon” is a registered trademark of Saint-Gobain Norton), latex tubes and polyethylene tubes are preferable.

In order to raise the ink resistance, it is preferable for the tubes to have a two-layer structure. For example, it is preferable to use tygon for the outer layer and a fluorocarbon resin for the inner layer. It is also preferable to combine a material with low gas transmissivity, a polyethylene/alcohol copolymer and a polyvinylidene chloride.

Also, in a case where pumps of a type that works the tubes, such as roller pumps, are used, it is preferable to use soft silicon tubes. Tube materials respectively suited for the main supply path 72, the main return path 74, the ink circulation path 36 and the individual flow paths 48 may also be used.

It is preferable for the recording heads 44 to be inkjet recording heads that can discharge ink droplets from nozzle surfaces 40A of the recording heads 44, regardless of the type of ink and format of discharging the ink droplets. The format of discharging the ink droplets of the unit heads 40 is not limited to the inkjet format and may be of a type that transfers color material directly to the paper without contacting the paper. The inkjet format is representative, but any other known format is also applicable. Also, the inkjet format is not limited to the thermal inkjet format, piezo-type inkjetting, continuous flow-type inkjetting or electrostatic suction-type inkjetting.

Also, for the ink to be used, a water-based ink, an oil-based ink and a solvent-based ink are all applicable. The color material in the ink may be a pigment or dye.

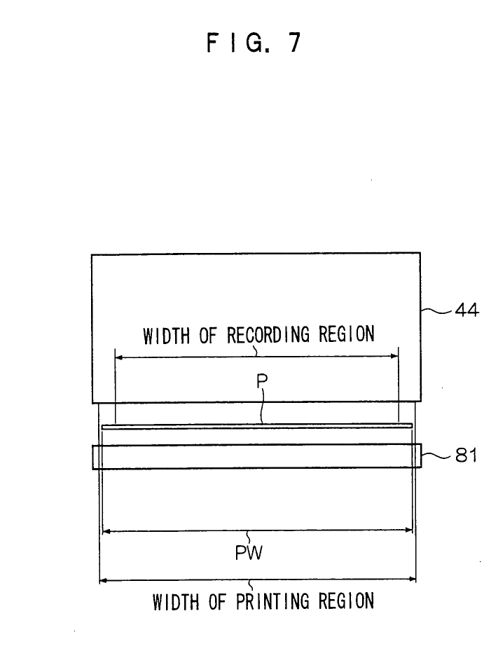

As shown in FIG. 7, the printing region of the recording head 44 is set in correspondence to a maximum paper width PW of paper P that is to be printed. Here, the printing region is basically the maximum region of the recording region excluding the margins that are not to be printed from both end of the paper, but usually the printing region is larger than the maximum paper width PW serving as the printing target. This is because there is the potential for the paper to be slanted (skewed) by a predetermined angle with respect to the conveyance direction and conveyed, and also because the demand for no edge printing is high.

The recording head 44 may be configured by a monolithic long recording head chip or by plural short recording head chips (below, unit heads).

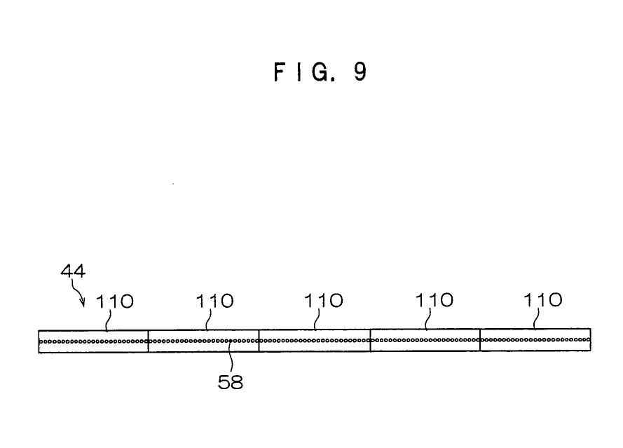

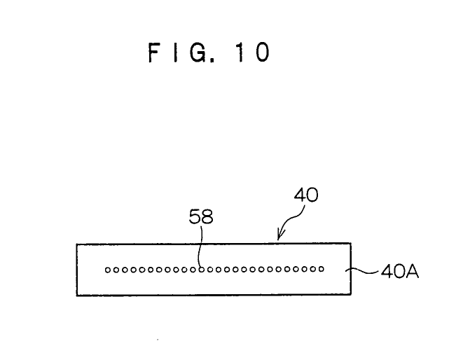

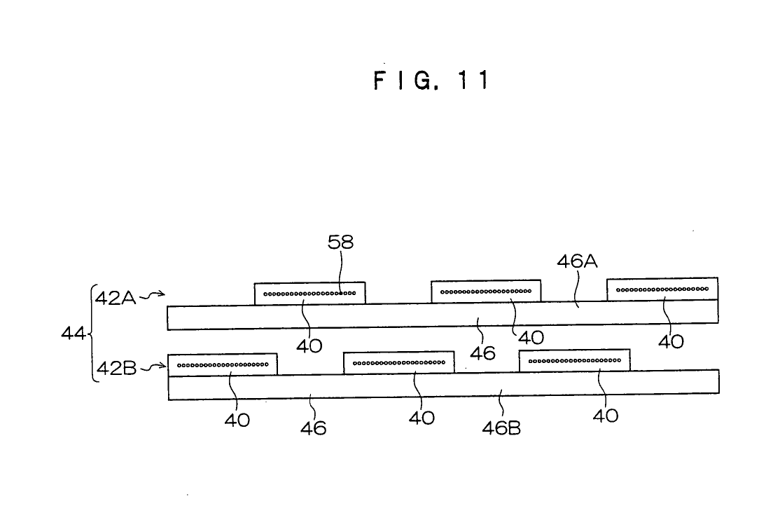

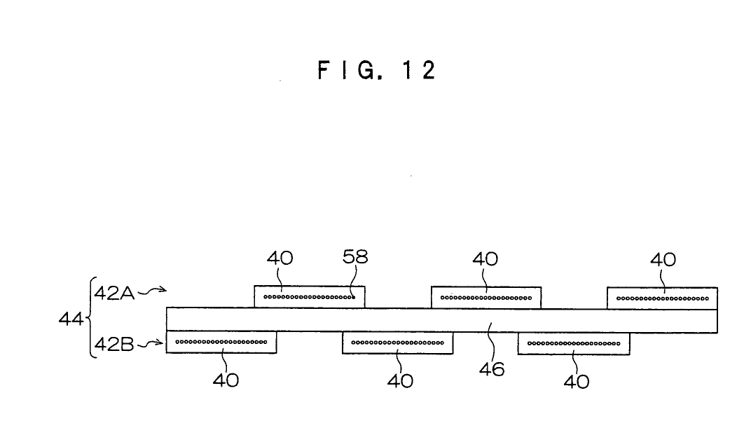

For example, if a unit head 110 is of a type where nozzles 58 are formed as far as end portions in the nozzle arrangement direction (see FIG. 8), the recording head 44 shown in FIG. 9 can be configured compactly by continuously disposing the unit heads 110 in the nozzle arrangement direction. Also, in a case where, as shown in FIG. 10, a unit head 40 in which the nozzles 58 are not formed near both ends is used, a recording head 44 where printing at a predetermined pitch is possible across the entire paper width can be configured by plurally disposing, in the conveyance direction, recording head arrays 42A and 42B where the unit heads 40 are plurally disposed at constant intervals on common substrates 46A and 46B (see FIG. 11). Alternatively, as shown in FIG. 12, miniaturization can be further improved by disposing the recording head arrays 42A and 42B on both sides of a single common substrate 46.

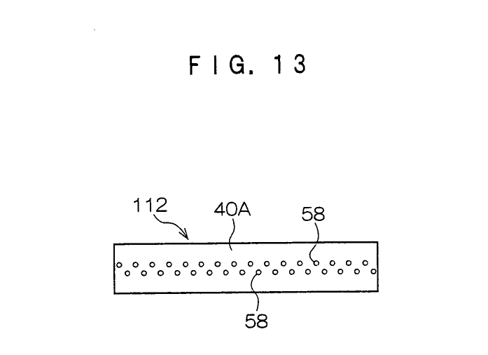

The arrangement of the nozzles of the unit heads 40 is linear but not limited to this. For example, as shown in FIG. 13, the nozzles 58 can be arranged in a staggered manner.

The inkjet recording apparatus 10 of the present embodiment is configured so that four (or more) recording heads 44 are arranged at predetermined intervals in the conveyance direction and ink droplets of yellow, magenta, cyan and black are discharged, so that the inkjet recording apparatus 10 can record a full-color image. The subtank 34′ is disposed for each recording head 44 or each recording head array 42A and 42B, and the main tank 68 is disposed for each color (thus, at least four).

As shown in FIG. 6, connection flow paths 56 connected to the individual flow paths 48 are disposed for each unit head 40. Attachment units 122 and 124 are disposed at the portions where the individual flow paths 48 are connected to their corresponding connection flow paths 56. Thus, the unit heads 40 can be easily, and mutually independently, attached to and removed from the individual flow paths 48. Unillustrated individual open/close valves are disposed in the attachment units 122 and 124 and can be individually opened and closed for each of the portions where the individual flow paths 48 and the connection flow paths 56 are connected.

A maintenance device 81 disposed facing each recording heads 44 is at least disposed with cap devices (ink accommodating devices) 80 that correspond to the respective unit heads 40 and can accommodate the ink droplets. The cap devices 80 have the function of accommodating and retaining the liquid droplets discharged from the recording head 44. In order to realize this, the cap devices 80 can be configured by a receiving member 82, which includes a concave portion 82A formed so as to correspond to the nozzle surface 40A (see FIG. 8) of the recording head 44, and an ink absorber 86, which is disposed at the bottom of the concave portion 82A of the receiving member 82 and retains the ink. The receiving members 82A are tightly adhered to the nozzle surface 40A to place them in an airtight state.

As shown in FIG. 6, a first chamber 212 shared by one entire recording head 44 is disposed below the receiving members 82, and the receiving members 82 and the first chamber 212 are connected by first drainage ink flow paths 214 disposed with drainage path open/close valves 216.

A second chamber 218 and a third chamber 220 are connected in order from the first chamber 212 by a second drainage ink flow path 222 and an intake flow path 224. The drainage ink from the first chamber 212 can be returned to the main tank 68 (or the subtank 34′) by opening a return-use valve 228 disposed in an ink return path 226 and switching a switching valve 229, or can be discharged to the outside from a discharge path 232 by sending the drainage ink along the second drainage ink flow path 222 to the second chamber 218 and opening a discharge-use valve 230.

An intake pump 236 is connected to the third chamber 220 via an intake tube 234, and negative pressure is generated inside the third chamber 220 by opening and closing an intake valve 238. The negative pressure can act on the receiving members 82 via the second chamber 218 and the first chamber 212.

Atmosphere open valves 240 and 242 are disposed for the first chamber 212 and the third chamber 220, and the insides of these chambers can be opened to atmospheric pressure.

The drainage path open/close valves 216, the return-use valve 228, the discharge-use valve 230, the intake valve 238 and the atmosphere open valves 240 and 242 can be controlled overall by a maintenance controller 244.

In the present embodiment, the ink inside the main tank 68 is circulated between the main tank 68 and the subtank 34′ and supplied to the subtank 34′ by a main circulation device configured by the main supply path 72, the main return path 74 and the main pump 76.

The ink inside the subtank 34′ is circulated and supplied to each of the unit heads 40 by a subcirculation device configured by the ink circulation path 36, the ink return path 37 and the subpump 38.

The ink can be supplied to the unit heads 40, for which ink supply is necessary, by appropriately controlling the opening and closing of the unillustrated individual open/close valves, so that unnecessary ink consumption can be avoided.

In this manner, because the ink is circulated not only between the subtank 34′ and the recording heads 44 but also between the main tank 68 and the subtank 34′, the ink stored in the main tank 68 can be stably supplied to the recording heads 44 via the subtank 34′.

In a case of the inkjet recording apparatus 10 formed by plurally arranging head rows (recording heads 44) comprising the plural unit heads 40 as in the present embodiment, a large amount of ink can be discharged in a short amount of time. Even in such a case, ink necessary for image recording can always be stably supplied to the recording heads 44. Thus, even in a case where a large amount of image recording is conducted at a high speed, images with a stable image quality can be recorded.

Due to the overflow walls 62 disposed in the subtanks 34′, excessive ink inside the ink retention chambers 34S is allowed to overflow so that the level of ink can be maintained to a constant. Thus, a constant water head difference D can always be obtained between the subtanks 34′ and the ink discharge plane of the recording heads 44, regardless of the capacity and shape of the subtanks 34′. Because the meniscus of the ink at the ink discharge ports is stable, the discharge state of the ink (discharge direction and ink droplet volume) is also stable, so that high-quality images can be recorded.

Because the ink can be continuously supplied from the main tank 68 to the subtank 34′, changes in the level of ink inside the subtank 34′ (ink retention chamber 34S) can be prevented.

The overflowing ink is returned from the ink return chamber 34R to the main tank 68 so that it can be reused inside the inkjet recording apparatus 10 and is not unnecessarily consumed.

In order to maintain the water head difference D in a constant range, it is necessary to ensure that the amount of ink in the ink retention chamber 34S does not become too small. In the present embodiment, the level of ink is detected by the level sensors 78 disposed in the ink retention chamber 34S, the main pump 76 is driven as needed so that the level of ink in the ink retention chamber 34S does not fall below a predetermined height, and the ink is supplied from the main tank 68. For example, because the water head pressure that can stably form a meniscus at the ink discharge ports is generally in the range of 0.45 kPa to 1.00 kPa, it is preferable for the ink retention chamber 34S to have a depth that can accommodate this range. Additionally, it is preferable for the level of the ink in the ink retention chamber 34S to be detected by the level sensors 78, the main pump 76 to be driven so that the lower limit of the level does not fall below the above range, the ink to be supplied from the main tank 68 to the subtank 34′, and the level of ink in the ink retention chamber 34S to be maintained in a constant range.

It is preferable for the subpump 38 and the main pump 76 that are ink flow generators of the present embodiment to be pumps that can reliably generate an ink flow and supply the ink to the recording heads 44 or the subtank 34.

In order to know the capability required in a case where a roller pump is used as the subpump 38 as in the present embodiment, the ink consumption amount at the time of the highest load (when it is necessary to supply the largest amount of ink) can be calculated as follows.
(1) Number of unit heads corresponding to one subpump: 6
(2) Nozzle density per unit head: 800/inch
(3) Printing frequency: 9 kHz
(4) Volume of ink droplets: 10 pl

From these, the ink consumption amount (flow rate) Q at the time of the highest load is determined by the following equation.
Q=6×800×(9×10³)×(10×10⁻⁹)=0.432 ml/sec

Also, in a vacuum operation of the unit heads 40 conducted at the time of maintenance, the flow rate Q depends on the negative pressure condition but is about 0.25 ml/sec per unit head, and about 1.5 ml/sec in terms of the overall recording head 44.

Thus, it is preferable for the capability of the ink flow generators and roller pump to be variable within the range of flow rates of 0 ml/sec to 1.5 ml/sec. It is more preferable for the flow rate to be set to match the printing load and various operating modes.

As described above, according to the invention, ink can be stably supplied to recording heads.

1. An ink supplying apparatus comprising:
a recording head unit;
a first tank and a second tank that can retain ink for the recording head unit;
a first circulation device that can circulate the ink between the recording head unit and the first tank; and
a second circulation device that can circulate the ink between the first tank and the second tank.

2. The ink supplying apparatus of claim 1, wherein the first tank includes
a retention chamber of a predetermined capacity that can accommodate ink returned from the recording head unit and ink supplied from the second tank, and
a return chamber that recovers ink overflowing from the retention chamber and returns the ink to the second circulation device.

3. A recording apparatus comprising:
(i) plural recording heads that can discharge ink droplets onto a recording medium; and
(ii) an ink supplying apparatus that can supply ink to the recording heads, the ink supplying apparatus including
a first tank and a second tank that can retain the ink,
a first circulation device that can circulate the ink between the recording heads and the first tank, and
a second circulation device that can circulate the ink between the first tank and the second tank.

4. The recording apparatus of claim 3, wherein the recording heads are arranged in a predetermined direction.

5. The recording apparatus of claim 3, wherein
each of the recording heads includes plural unit heads,
each of the unit heads is disposed with a dedicated individual flow path, and
each of the individual flow paths is connected to the first circulation device and can supply the ink to its corresponding unit head.

6. The recording apparatus of claim 3, wherein the first tank includes
a retention chamber of a predetermined capacity that can accommodate ink returned from the recording heads and ink supplied from the second tank, and
a return chamber that recovers ink overflowing from the retention chamber and returns the ink to the second circulation device.
